(19) United States
(12) Patent Application Publication
(10) Pub. No.: US 2011/0270431 A1
(43) Pub. Date: Nov. 3, 2011

(54) WELL PRODUCTION SHUT DOWN

(76) Inventors: Stuart Guy Holley, Nailsea (GB); Ian J. Kent, Nailsea (GB); Vernon Lester Hutchings, Thornbury (GB)

(21) Appl. No.: 13/091,572

(22) Filed: Apr. 21, 2011

(30) Foreign Application Priority Data
Apr. 29, 2010 (GB) 1007150.4

(51) Int. Cl. G06F 19/00

(52) U.S. Cl. 700/108

(57) ABSTRACT

A system for controlling production shut down of an underwater fluid production well, the well having a sensor for producing an output signal indicative of the state of the well and a valve which is actuable to shut down production activity of the well, comprises means for receiving the output signal; and a processor for processing the received signal to determine if a shut down is required and outputting a shut down signal to the valve; wherein the receiving means and processor are located at the well.

### FIELD OF INVENTION

This invention relates to a method and system for controlling production shut down of an underwater fluid production well, for example a subsea hydrocarbon extraction well.

### BACKGROUND OF THE INVENTION

A preferred current method available to a well operator for shutting down a single subsea well in a multiple well complex is via the surface platform. Data such as pressures and temperatures relating to the operation of the well are transmitted to the surface platform through the well communication system typically via an umbilical cable. Such data are typically monitored by the well operator. The need to shut down a well is usually automatically determined by an integrated control and safety system (ICSS) which is a safety integrity level (SIL) rated system located at the surface, though the operator may instigate this manually via the ICSS. Usually the ICSS is connected to vent valves on the subsea high pressure unit (HPU) which when opened cause the hydraulic supplies in the umbilical to depressurise, and as a result the well will eventually shut in, with the time taken to do so being dependent on the length of the umbilical. If it is determined that a well shut down is required in a controlled and timely manner, a command is transmitted through the same communication system to a subsea electronic module (SEM) of the the subsea well tree, the command typically resulting in the closing of a production wing valve, followed by operation of the vent valves at the HPU to ensure that the system vents and shuts in. The command signal from the surface platform is received by a subsea electronics module (SEM) located in a subsea control module (SCM), which may be located at the well head. The SEM electronics drives a directional control valve (DCV) in the SCM, which in turn controls the hydraulic supply to operate the production wing valve.

A known system is shown in FIG. 1. As shown, a production flowline 1 is fitted with a number of valves to control and protect the system, which include a surface-controlled subsurface safety valve (SCSSV) 2, a production master valve (PMV) 3, a production wing valve (PWV) 4 and a flow control choke 5. The valves 2, 3 and 4 are hydraulically operated and are self-returning, in that with a loss of hydraulic power the valves close automatically, for example under bias by return springs. Hydraulic power is fed to valves 2, 3 and 4 via directional control valves (DCVs, not shown) located within a subsea control module (SCM) 6, which is mounted on the well tree. Electrical operating solenoids of the DCVs are driven by the electronics of a subsea electronics module (SEM) 7 located within SCM 6. In FIG. 1, two SEMs 7 are shown, providing back up safety in the event of failure of one SEM 7. The SEMs 7 are fed with control signals from a topside control system 8 located on a surface platform via an umbilical through a so-called ‘black channel’ (as described in GB-A-2452948 for example). Any requirement to shut down the well, such as in an emergency, is effected by control signals transmitted from the topside control platform 8 to a SEM 7 and associated DCVs, to actuate the appropriate valves to achieve a production shut down (PSD). The decision to shut down the well is made via an ICSS 12 as described above, typically from observations of temperatures and pressures which may for example be transmitted from sensors 9, 10 and 11 located on the well. In this case, in order to effect shutdown, a signal from at least one sensor 9, 10, 11 must be passed to the surface-located ICSS 12 via a SEM 7 and the umbilical, processed by the ICSS 12, and then a shut down control signal is sent by the ICSS 12, through umbilical to the subsea well head, via a SEM 7 to cause at least one DCV to activate, which in turn causes closure of at least one valve, for example a vent valve or production wing valve.

A problem with such a system is that it is lengthy and complex, involving a large number of components, and communication is required from well head sensors to the surface and back again, and this leads to lower than desired reliability. Indeed, such known systems have such a poor ‘probability of failure on demand’ that they are unlikely to achieve even the lowest safety integrity level (SIL) rating, which is SIL 1.

it is an aim of the present invention to overcome this problem and improve the reliability of the shut down system. This aim is achieved by providing a shut down processing function at the well.

Such an implementation of a production shut down (PSD) system that locally, i.e. subsea, detects a fault condition using sensors and a local processor, employing SIL rateable software, may effect a PSD without the need to communicate with the surface. The system ideally permits a PSD by command from the surface if required but does not rely on this communication in the event of the need for a PSD in an emergency. Furthermore, a failure of the black channel communication or electric power from the surface, ideally results in a locally operated PSD.

In this way, the safety integrity of the well production shut down system is assured by the local process as it can be SIL rated, whilst still allowing a traditional PSD by command from the topside control system.

### SUMMARY OF THE INVENTION

In accordance with a first aspect of the present invention there is provided a method for controlling production shut down of an underwater fluid production well, comprising the steps of:
a) monitoring an output signal from a sensor located at the well;
b) processing the signal to determine if a shut down is required; and
c) effecting shut down by sending a shut down signal to a device to cause actuation of a valve located at the well, said actuation causing the well to shut down production;
wherein in step b), the processing is performed by a processor located at the well.

In accordance with a second aspect of the present invention there is provided a system for controlling production shut down of an underwater fluid production well, the well having a sensor for producing an output signal indicative of the state of the well and a valve which is actuable to shut down production activity of the well, the system comprising:

means for receiving the output signal; and
a processor for processing the received signal to determine if a shut down is required and outputting a shut down signal to the valve;
wherein the receiving means and processor are located at the well.

### BRIEF DESCRIPTION OF THE DRAWINGS

The invention will now be described with reference to the accompanying drawings, in which:

FIG. 1 schematically shows a known well control system;

FIG. 2 schematically shows an embodiment of a well control system in accordance with the present invention; and

FIG. 3 schematically shows an enlarged portion of the system of FIG. 2.

### DETAILED DESCRIPTION OF THE INVENTION

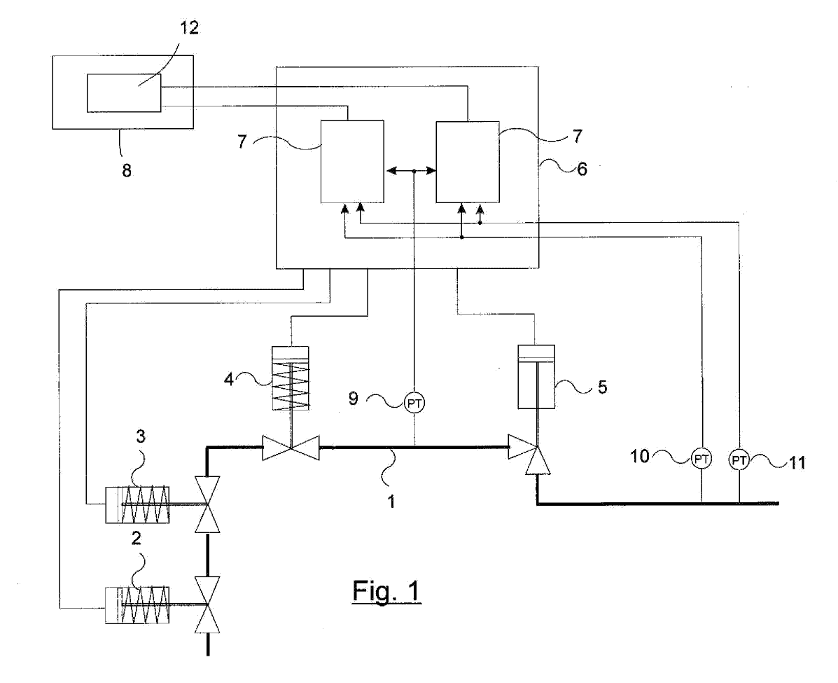

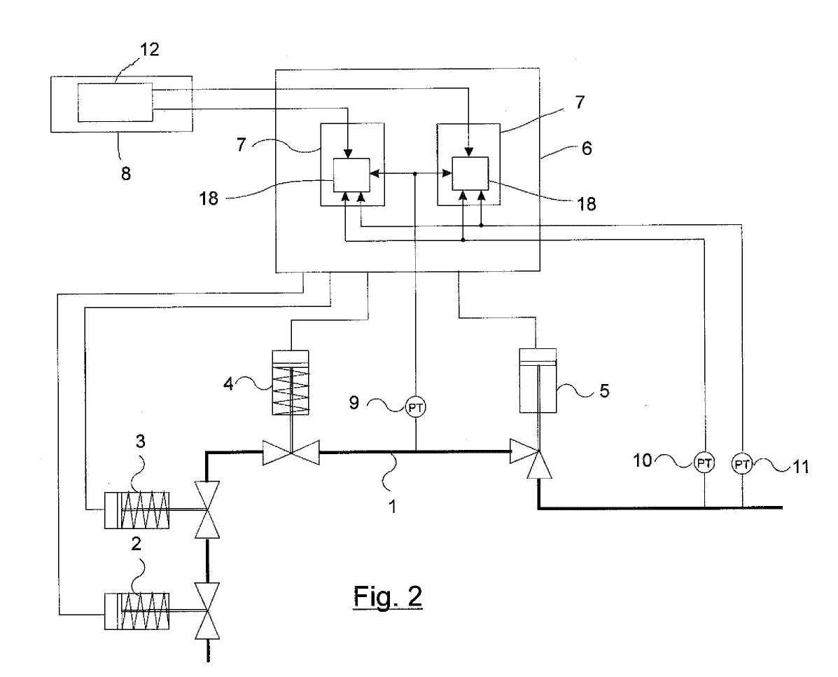

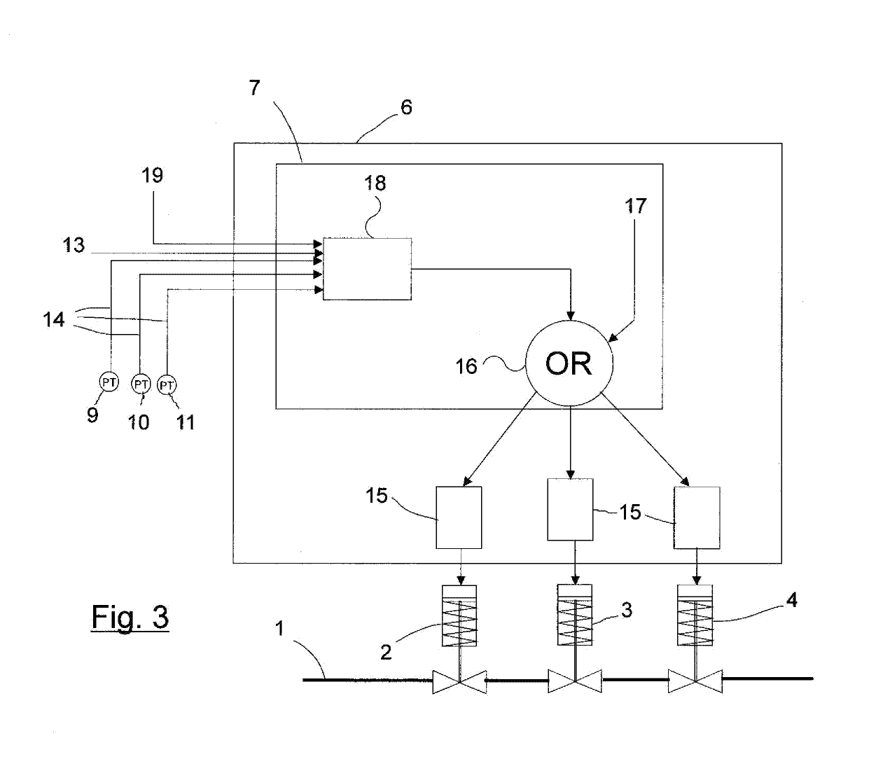

An embodiment of the invention is schematically shown in FIGS. 2 and 3. As far as possible, the numbering used in FIG. 1 is retained for like components.

In this embodiment there are many components in common with the known system of FIG. 1, which enables the inventive system to be retrofitted to an existing well system with a minimum of disruption. A local production shut down (PSD) processor 18 is fitted at a well head within a SEM 7. This processor 18 is relatively simple, with relatively low complexity, and is therefore SIL rateable. In this embodiment, one processor 18 is provided within each SEM 7. In alternative embodiments (not shown) additional processors 18 may be provided within each SEM 7 to provide back-up functionality.

Each processor 18 is adapted to receive output signals from pressure/temperature sensors 9, 10 and 11, and process these as set out below. Each processor 18 is operable to identify when a production shut down is required by appropriate processing of these input signals, and to effect this production shut down. To this end, each processor 18 is also operable to output shut down control signals to DCVs controlling appropriate valves 2, 3, 4 (described in more detail below with respect to FIG. 3). Each processor 18 is also adapted to receive control signals 19 from ICSS 12 located at the topside platform 8.

The logic of this local PSD process is illustrated in FIG. 3. Predetermined limits 13 for pressures and temperatures are fed to the PSD processor 18, for example during initialisation pre-deployment, or during ongoing service. These limit data are stored within processor 18 or within SEM 7. In addition, the processor 18 receives system measurements 14 from the local pressure/temperature sensors 9, 10 and H. The processor 18 compares the system measurements 14 with the limits 13. In the event of a fault condition being detected, typically because at least one measurement 14 exceeds a limit 13, then the processor 18 outputs shut down operation control signals to appropriate DCVs 15, which act to control valves 2, 3 and 4. The shut down signal output from processor 18 is fed via an OR gate 16. Gate 16 also has a traditional ‘black channel’ input control 17 led to it as a command input, arranged such that loss of the black channel input, for example due to a loss of electric power at the surface, automatically causes gate 16 to activate DCVs 15 to dose the valves 2, 3 and 4, and thus achieve a production shut down.

As a further safety feature, each processor 18 is adapted to receive command signals 19 from ICSS 12 located at the surface, and to effect a PSD upon receipt of an appropriate command control signal from the ICSS 12.

The PSD processor 18 can be implemented in hardware. Alternatively, the processor 18 may comprise a software program, for example written in C, running in a relatively simple processor located within a SEM 7, which is therefore SIL rateable, to provide process flexibility. The processor may for example be housed in an electronics board within the SEM 7,

The above-described embodiments are exemplary only, and other possibilities and alternatives within the scope of the invention will be apparent to those skilled in the art. For example, in the above embodiment, shut down may be effected from the surface either by sending an appropriate control signal 19 to the processor, or by the absence of a black channel input 17, however in an alternative embodiment, command signals from ICSS 12 may bypass processor 18, and instead be passed directly to OR gate 16. Such an arrangement further increases the relatively simplicity of the system. Alternatively, control signals 19 from ICSS 12 may be dispensed with entirely, such that topside control is effected solely through black channel input 17.

While three pressure/temperature sensors 9-11 have been described, in fact the processor 18 may receive inputs from as many sensors as are provided at the well head.

While the embodiment described above compares the received sensor signals with preset limits 13, other methods for determing fault conditions may be used. For example, the processing system may track the change in sensor output over time, and act to effect shut down in the event that the rate of change of the sensor output exceeds a certain level. Alternatively, an intelligent system could be used in which outputs from various sensors can be monitored and compared to a model of expected behaviour.

What is claimed is:

1. A method for controlling production shut down of an underwater fluid production well, comprising the steps of:
monitoring an output signal from a sensor located at the well;
processing the signal to determine if a shut down is required; and
effecting shut down by sending a shut down signal to a device to cause actuation of a valve located at the well, said actuation causing the well to shut down production;
wherein in step b), the processing is performed by a processor located at the well.

2. A method according to claim 1, comprising the step of receiving, at the well, a control signal from a surface location and logically combining this with the processor output, such that a shut down signal may be received at the valve from either the processor or from the surface location.

3. A method according to claim 1, wherein the processor is adapted to receive control signal received from a surface location and output a shut down signal in dependence of the control signal.

4. A method according to claim 1, wherein the processor is SIL-rateable.

5. A method according to claim 1, wherein the processor determines if a shut down is required by comparing the sensor output with a predetermined limit.

6. A method according to claim 1, wherein the processor determines if a shut down is required by comparing the sensor output with a modelled behaviour.

7. A method according to claim 1, wherein the well comprises a plurality of sensors, and the processor receives and processes output signals from each of said plurality of sensors.

8. A method according to claim 1, wherein the processor is located within a subsea electronics module at the well head.

9. A method according to claim 1, wherein the valve comprises a directional control valve.

10. A method according to claim 1, wherein the well comprises a hydrocarbon extraction well.

11. A system for controlling production shut down of an underwater fluid production well, the well having a sensor for producing an output signal indicative of the state of the well and a valve which is actuable to shut down production activity of the well, the system comprising:
means for receiving the output signal; and
a processor for processing the received signal to determine if a shut down is required and outputting a shut down signal to the valve;
wherein the receiving means and processor are located at the well.

12. A system according to claim 11, comprising means, located at the well, for receiving a control signal from a surface location and logically combining this with the processor output, such that a shut down signal may be received at the valve from either the processor or from the surface location.

13. A system according to claim 11, wherein the processor is adapted to receive control signal received from a surface location and output a shut down signal in dependence of the control signal.

14. A system according to claim 11, wherein the processor is SIL-rateable.

15. A system according to claim 11, wherein the processor determines if a shut down is required by comparing the sensor output with a predetermined limit.

16. A system according to claim 11, wherein the processor determines if a shut down is required by comparing the sensor output with a modelled behaviour.

17. A system according to claim 11, wherein the well comprises a plurality of sensors, and the processor receives and processes output signals from each of said plurality of sensors.

18. A system according to claim 11, wherein the processor is located within a subsea electronics module at the well head.

19. A system according to claim 11, wherein the valve comprises a directional control valve.

20. A system according to claim 11, wherein the well comprises a hydrocarbon extraction well.
